(19) United States
(12) Patent Application Publication
(10) Pub. No.: US 2024/0368037 A1
(43) Pub. Date: Nov. 7, 2024

(54) Gypsum Panel Having Enhanced Sustainability

(71) Applicant: Gold Bond Building Products, LLC, Charlotte, NC (US)

(72) Inventors: Ratnasabapathy Gurunathan Iyer, Charlotte, NC (US); Eli Stav, Charlotte, NC (US)

(21) Appl. No.: 18/654,092

(22) Filed: May 3, 2024

Related U.S. Application Data
(60) Provisional application No. 63/500,003, filed on May 4, 2023.

(51) Int. Cl. C04B 28/14; C04B 24/12; C04B 103/30; C04B 103/40; C04B 111/00

(52) U.S. Cl. CPC C04B 28/14; C04B 24/124; C04B 2103/302; C04B 2103/408; C04B 2111/0062

(57) ABSTRACT

The present invention is directed to a gypsum panel with reduced water usage and a method of making such gypsum panel. For instance, in one aspect, the gypsum panel comprises a gypsum core and a first facing material and a second facing material sandwiching the gypsum core, wherein the gypsum core includes gypsum and a water reduction agent. The methods of the present invention are directed to making the aforementioned gypsum panels. For instance, a method may include providing the first facing material, providing a gypsum slurry comprising gypsum, water, and a water reduction agent onto the first facing material, and providing a second facing material on the gypsum slurry.

### RELATED APPLICATIONS

The present application is based on and claims priority to U.S. Provisional Patent Application Ser. No. 63/500,003, filed on May 4, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. Notably, the water to stucco ratio is an influential parameter that contributes to the fluidity of the gypsum slurry, the density of the gypsum core, and the hydration of the stucco in the gypsum slurry. In general, the theoretical water to stucco ratio (i.e., the amount of water utilized to convert the stucco into gypsum) is about 0.2; however, excess water is often utilized to provide effective conversion of the stucco into gypsum and/or to ensure acceptable gypsum slurry fluidity. Notably, the utilization of excess water may result in additional energy used in the drying of the gypsum panel, increased production costs, and reduced long-term sustainability.

As a result, there is a need to provide an improved, sustainably manufactured gypsum panel that utilizes a reduced amount of water in the formation of the gypsum slurry and gypsum core.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises a gypsum core comprising gypsum and a water reduction agent, the water reduction agent being present in the gypsum panel in an amount from about 1 wt. % to about 20 wt. % based on the weight of the gypsum core; and a first facing material and a second facing material sandwiching the gypsum core.

In accordance with another embodiment of the present invention, a method of making a gypsum panel is disclosed. The method comprises: providing a first facing material; depositing a gypsum slurry comprising stucco, water, and a water reduction agent onto the first facing material, providing a second facing material on the gypsum slurry; and allowing the stucco to convert to calcium sulfate dihydrate, wherein the water reduction agent is present in the gypsum panel in an amount from about 1 wt. % to about 20 wt. % based on the weight of the gypsum core.

In accordance with one embodiment of the present invention, a gypsum panel is disclosed. The gypsum panel comprises a gypsum core comprising gypsum and a water reduction agent, wherein the gypsum core is formed from a gypsum slurry comprising a ball-milled mixture of the water reduction agent and a stucco; and a first facing material and a second facing material sandwiching the gypsum core.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including a water reduction agent as defined herein. In this regard, the gypsum core may include gypsum (i.e., calcium sulfate dihydrate), a water reduction agent, and may include other optional additives. The present inventors have discovered that the gypsum panel disclosed herein can have various benefits due to the use of a water reduction agent. For instance, the present inventors have discovered that the mechanical properties and characteristics of the gypsum panel may be improved. For instance, the gypsum panel disclosed herein may have increased nail pull resistance, increased panel strength, and/or enhanced bonding between the gypsum core and one or more of the respective facing materials.

In general, a gypsum panel formed in accordance with the present disclosure may be formed in a more sustainable or environmentally friendly manner as compared to the formation of traditional gypsum panels. For instance, a gypsum panel formed in accordance with the present disclosure may utilize less water in the formation of the gypsum slurry as compared to a traditional gypsum panel. Further, during the production of a gypsum panel, the gypsum panel generally undergoes a drying process. Notably, a reduction in the water usage may decrease the energy utilized to dry a gypsum panel. In this respect, the energy utilized in the process of forming a gypsum panel in accordance with the present disclosure may be lower as compared to the energy utilized in the process of forming a traditional gypsum panel.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

In general, the gypsum core may comprise calcium sulfate dihydrate. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In addition, the gypsum core may comprise a water reduction agent. The water reduction agent may reduce the amount of water utilized in forming the gypsum slurry. It should be understood that the gypsum core disclosed herein may comprise more than one water reduction agent. For instance, the gypsum core disclosed herein may comprise two water reduction agents or three water reduction agents. The one or more water reduction agents may be selectively chosen to form a combination of water reduction agents that synergistically interact to reduce the water utilized to form a gypsum panel. In some aspects, the water reduction agent may enhance the antifungal and/or antimicrobial properties of a gypsum panel. In this respect, the water reduction agent may prevent or reduce fungal and/or microbial growth in a gypsum panel.

The water reduction agent of the present disclosure may include an amide (e.g., a primary amide, a secondary amide, a tertiary amide, or a combination thereof). For instance, the water reduction agent may include urea, which generally has the chemical formula CO(NH₂)₂. In some aspects, the water reduction agent may include urea-formaldehyde.

Generally, a gypsum panel formed in accordance with the present disclosure may have one or more water reduction agents added to or incorporated in a gypsum slurry and/or gypsum core at any time of the process disclosed herein, including at, before, and/or after any of the process steps disclosed herein.

Generally, a water reduction agent may be present in any element of the disclosed gypsum panel. For instance, a water reduction agent may be present in one or more of the facing materials of the gypsum panel. Additionally or alternatively, for instance, a water reduction agent may be present in the gypsum slurry and/or the gypsum core of the gypsum panel. Further, for instance, a water reduction agent may be present in one or more gypsum core layers (e.g., first gypsum core layer, second gypsum core layer, third gypsum core layer) of the gypsum panel.

In general, the water reduction agent may be combined with stucco (i.e., calcium sulfate hemihydrate) before the stucco is mixed and/or reacted with water. In this respect, the stucco and the water reduction agent may be mixed before the stucco and the water reduction agent are contacted and/or reacted with water. The stucco and water reduction agent may be combined by any method known in the art or disclosed herein. For instance, the stucco and the water reduction agent may be mixed or combined as is or may be ground or milled together, such as by dry milling or wet milling. In yet another aspect, the water reduction agent may be combined with the stucco after the stucco has been introduced, contacted, and/or mixed with water. In this respect, the water reduction agent may be combined with the stucco and water after the stucco and water have partially reacted. In yet another further aspect, the stucco, water, and water reduction agent may all be combined simultaneously to form the gypsum slurry.

Notably, a water reduction agent (e.g., an amide), stucco, starch, and/or gypsum may be mixed and/or milled at any time of the process disclosed herein, including during, before, and/or after any of the process steps disclosed herein (e.g., before being contacted with water to form a gypsum slurry and/or gypsum core). In this respect, the gypsum slurry may comprise a milled (e.g., ball-milled) mixture of an amide (e.g., urea), stucco, starch, and/or gypsum. In one aspect, a water reduction agent, stucco, and/or gypsum may be mixed and milled together before being incorporated into the gypsum slurry. In general, milling stucco, gypsum, and/or a water reduction agent before contacting the milled mixture of the stucco, gypsum, and/or the water reduction agent with water to form at least a portion of the gypsum slurry may increase the fluidity of a gypsum slurry as compared to a gypsum slurry formed from stucco, gypsum, and/or a water reduction agent, and water, where the stucco, the gypsum, and/or the water reduction agent are not milled together prior to being incorporated in or added to the gypsum slurry. In this respect, a milled mixture of stucco, gypsum, and/or a water reduction agent, such as a ball-milled mixture of stucco, gypsum, and/or a water reduction agent, may decrease the amount of water utilized in forming a gypsum slurry and/or gypsum core.

As previously disclosed herein, a water reduction agent, stucco, starch, and/or gypsum may be ball-milled. However, it should be understood that a water reduction agent, stucco, starch, and/or gypsum may be milled or ground by other equipment such as, for instance, an attritor, a vibration mill, an impact mill, a planetary ball mill, a jet mill, and the like.

Generally, a milled mixture comprising a water reduction agent and stucco may have a stucco content from about 50 wt. % to about 99 wt. %, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more by weight of the milled mixture. In general, a milled mixture comprising a water reduction agent and stucco may have a stucco content of about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less by weight of the milled mixture.

Notably, a milled mixture comprising a water reduction agent and gypsum may have a gypsum content from about 50 wt. % to about 99 wt. %, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more by weight of the milled mixture. In general, a milled mixture comprising a water reduction agent and gypsum may have a gypsum content of about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less by weight of the milled mixture.

In some aspects, a milled (e.g., ball-milled) mixture comprising a water reduction agent, stucco, and/or gypsum may have a water reduction agent content (e.g., amide content, urea content) from about 1 wt. % to about 60 wt. %, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more by weight of the milled mixture. In general, a milled (e.g., ball-milled) mixture comprising a water reduction agent, stucco, and/or gypsum may have a water reduction agent content of about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less by weight of the milled mixture.

As indicated above, the gypsum slurry may include water. Water may be employed for fluidity and also for rehydration of the gypsum to allow for setting.

The weight ratio of the water to the stucco and/or the weight ratio of water to a milled mixture comprising stucco and a water reduction agent may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio and/or the water to a milled mixture comprising stucco and a water reduction agent weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less. In another aspect, the aforementioned weight ratios may apply to the weight ratio of water to a milled mixture comprising gypsum and a water reduction agent.

In general, a water reduction agent may be incorporated in and/or applied to a gypsum core, a gypsum slurry, and/or a facing material in various forms. For instance, the water reduction agent may be processed such that the water reduction agent is prilled, granulated (e.g., fine granulated particles, coarse granulated particles), in solution, or a combination thereof. Generally, a prilled water reduction agent may dissolve in water more rapidly than a granulated water reduction agent. Additionally, in some aspects, a prilled water reduction agent may have a more narrow particle size distribution when compared to a granulated water reduction agent. In this respect, the range of particle sizes of a prilled water reduction agent may be less than the range of particle sizes of a granulated water reduction agent.

Generally, the water reduction agent may have a nitrogen content of about 10 wt. % to about 70 wt. %, including all increments of 0.1 wt. % therebetween. For instance, the water reduction agent may have a nitrogen content of about 10 wt. % or more, such as about 20 wt. % or more, such as about 30 wt. % or more, such as about 40 wt. % or more, such as about 50 wt. % or more, such as about 60 wt. % or more. In general, the water reduction agent may have a nitrogen content of about 70 wt. % or less, such as about 60 wt. % or less, such as about 50 wt. % or less, such as about 40 wt. % or less, such as about 30 wt. % or less, such as about 20 wt. % or less.

In general, the water reduction agent may have a formaldehyde content of about 0 wt. % to about 10 wt. %, including all increments of 0.1 wt. % therebetween. For instance, the water reduction agent may have a formaldehyde content of about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, the water reduction agent has a formaldehyde content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the water reduction agent may be substantially free of formaldehyde. As used herein, a water reduction agent “substantially free” of formaldehyde has a formaldehyde content of less than about 2 wt. %.

In some aspects, the water reduction agent may have a biuret content of about 0 wt. % to about 10 wt. %, such as about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, the water reduction agent has a biuret content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the water reduction agent may be substantially free of biuret. As used herein, a water reduction agent “substantially free” of biuret has a biuret content of less than about 2 wt. %.

Generally, the water reduction agent has a bulk density from about 275 kg/m³ to about 1000 kg/m³, such as about 275 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more, such as about 900 kg/m³ or more. In general, the water reduction agent may have a bulk density of about 1000 kg/m³ or less, such as about 900 kg/m³ or less, such as about 800 kg/m³ or less, such as about 700 kg/m³ or less, such as about 600 kg/m³ or less, such as about 500 kg/m³ or less, such as about 400 kg/m³ or less.

In order to provide the desired effect, the water reduction agent may have a selectively chosen average particle size. For instance, the water reduction agent may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less. The water reduction agent may have an average particle size of 20 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the water reduction agent. In this respect, the water reduction agent may have a D10, D50, or D98 Of any of the values previously disclosed, including any incremental values therebetween. Notably, in one aspect, the aforementioned values may refer to the agglomerate size of the water reduction agent. In one aspect, the aforementioned values may refer to the agglomerate size and the particle size of the water reduction agent. In this respect, the aforementioned values may refer to the combined average and/or combined median size of the agglomerates (i.e., particle agglomerates) and the individual particles of the water reduction agent. For instance, if a water reduction agent contains 30 wt. % agglomerates and 70 wt. % individual particles, all of the sizes of the agglomerates and the individual particles may be analyzed to determine an average and/or median of the combined agglomerates and individual particles.

Generally, the water reduction agent may have a selectively chosen particle size distribution. The particle size distribution of the water reduction agent may be monomodal, bi-modal, or multi-modal. The one or more modes may fall within any of the particle size values, including any ranges thereof, disclosed herein. In one aspect, a US standard mesh size of 4 (i.e., 4.75 mm) to 50 (i.e., 0.3 mm) may retain from 0 wt. % to about 100 wt. % of the water reduction agent, including all increments of 0.01 wt. % therebetween. In some aspects, a US standard mesh size of 6 may retain about 10 wt. % to about 30 wt. % of the water reduction agent, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less. In some aspects, a US standard mesh size of 7 may retain about 50 wt. % to about 85 wt. % of the water reduction agent, such as about 50 wt. % or more, such as about 60 wt. % or more, such as about 70 wt. % or more, such as about 80 wt. % or more, such as about 85 wt. % or less, such as about 80 wt. % or less, such as about 70 wt. % or less, such as about 60 wt. % or less. In some aspects, a US standard mesh size of 10 may retain about 90 wt. % to about 100 wt. % of the water reduction agent, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 18 may retain about 90 wt. % to about 100 wt. % of the water reduction agent, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 30 may retain about 90 wt. % to about 100 wt. % of the water reduction agent, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In one aspect, any of the aforementioned percentage values may be based on volume percent.

The water reduction agent may be present in the gypsum panel in an amount of 0.001 lbs/MSF to 150 lbs/MSF, including all increments of 0.001 lbs/MSF therebetween. For instance, the water reduction agent may be present in the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more, such as 50 lbs/MSF or more, such as 60 lbs/MSF or more, such as 80 lbs/MSF or more, such as 100 lbs/MSF or more, such as 120 lbs/MSF or more, such as 140 lbs/MSF or more. Generally, the water reduction agent may be present in the gypsum panel in an amount of 150 lbs/MSF or less, such as 140 lbs/MSF or less, such as 120 lbs/MSF or less, such as 100 lbs/MSF or less, such as 80 lbs/MSF or less, such as 60 lbs/MSF or less, such as 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, in some aspects, a water reduction agent may be present in a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more. In some aspects, the water reduction agent may be present in a gypsum panel and/or any component thereof in an amount of 15 wt. % or less, such as 14 wt. % or less, such as 13 wt. % or less, such as 12 wt. % or less, such as 11 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

It should be understood that a water reduction agent in accordance with the present disclosure may be calcined or uncalcined.

In general, the concentration of a water reduction agent may be higher in the area of the gypsum core near a respective facing material and may decrease across a thickness of the gypsum core. In one aspect, any of the respective gypsum core layers (e.g., first gypsum core layer, second gypsum core layer, third gypsum core layer) may have a higher concentration of the water reduction agent than the other gypsum core layers. For instance, in one aspect, the first gypsum core layer and/or third gypsum core layer may have a higher concentration of a water reduction agent than the second gypsum core layer. In some aspects, one or more gypsum core layers may be free of a water reduction agent. Notably, in some aspects, one or more gypsum core layers may be substantially similar except for the concentration of the water reduction agent in the respective gypsum core layers.

Generally, the water reduction agent may be heterogeneously or nonuniformly dispersed in the gypsum core. In one aspect, the concentration of the water reduction agent may be such that a concentration gradient of the water reduction agent is formed in a gypsum core and/or gypsum core layer. In some aspects, the concentration gradient may be such that the concentration of the water reduction agent increases or decreases over a portion of a thickness, such as a thickness disclosed herein, of a gypsum core and/or gypsum core layer formed in accordance with the present disclosure. In one aspect, a gypsum core formed in accordance with the present disclosure may have a higher concentration of the water reduction agent in the portion of the gypsum core adjacent to the first facing material (e.g., the first gypsum core layer) with the concentration of the water reduction agent decreasing across a dimension (e.g., the thickness) of the gypsum core. In general, in one aspect, the concentration of the water reduction agent in the gypsum core may decrease across a thickness of a gypsum core beginning at the portion of the gypsum core adjacent the first facing material and ending at the portion of the gypsum core adjacent the second facing material or ending at the center of the thickness of the gypsum core. It should be understood that the center of the thickness of the gypsum core is parallel to one or more respective facing materials and is a plane that extends the length and width of the gypsum core.

Generally, a gypsum core formed in accordance with the present disclosure may have a higher concentration of the water reduction agent in the portion of the gypsum core adjacent to the second facing material (e.g., the third gypsum core layer) with the concentration of the water reduction agent decreasing across a dimension (e.g., the thickness) of the gypsum core. In general, the concentration of the water reduction agent in the gypsum core may decrease across the thickness of a gypsum core beginning at the portion of the gypsum core adjacent the second facing material and ending at the portion of the gypsum core adjacent the first facing material or ending at the center of the thickness of the gypsum core.

Generally, a gypsum core (e.g., set gypsum core) formed in accordance with the present disclosure may have a higher concentration of the water reduction agent in the portion of the gypsum core adjacent to the first facing material as compared to the concentration of the water reduction agent in the portion of the gypsum core adjacent to the second facing material. In this respect, the concentration of the water reduction agent in the portion of the gypsum core adjacent to the first facing material may be higher than the concentration of the water reduction agent in the portion of the gypsum core adjacent to the second facing material. In another aspect, a gypsum core (e.g., set gypsum core) formed in accordance with the present disclosure may have a higher concentration of the water reduction agent in the portion of the gypsum core adjacent to the second facing material as compared to the concentration of the water reduction agent in the portion of the gypsum core adjacent to the first facing material. In this respect, the concentration of the water reduction agent in the portion of the gypsum core adjacent to the second facing material may be higher than the concentration of the water reduction agent in the portion of the gypsum core adjacent to the first facing material.

In one aspect, a gypsum core (e.g., set gypsum core) formed in accordance with the present disclosure may have a higher concentration of the water reduction agent in the portion of the gypsum core adjacent to the second facing material (e.g., the third gypsum core layer) with the concentration of the water reduction agent decreasing across a dimension (e.g., the thickness) of the gypsum core. As used herein, a “set gypsum core” refers to the gypsum core after the drying process of the gypsum panel, which may include drying the gypsum panel in a heating or drying device (e.g., kiln). In general, in one aspect, the concentration of the water reduction agent in the gypsum core may decrease across a thickness of a gypsum core beginning at the portion of the gypsum core adjacent the second facing material and ending at the portion of the gypsum core adjacent the first facing material or ending at the center of the thickness of the gypsum core.

In some aspects, the concentration of the water reduction agent in the gypsum core (e.g., set gypsum core) may be higher in the portions of the gypsum core adjacent to the respective facing materials (e.g., the first gypsum core layer and the third gypsum core layer). For instance, the concentration of the water reduction agent in the gypsum core may be higher in the portions of the gypsum core adjacent the first facing material and the second facing material, as compared to the center of the thickness of the gypsum core. In one aspect, a gypsum core formed in accordance with the present disclosure may have a higher concentration of the water reduction agent adjacent to the first facing material and the second facing material with the concentration of the water reduction agent decreasing toward the center of the thickness of the gypsum core beginning at the portions of the gypsum core adjacent the first facing material and second facing material respectively.

Notably, in one aspect, the three highest concentrations of the water reduction agent in a gypsum core (e.g., set gypsum core) may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the water reduction agent compared to the concentration of the water reduction agent in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the water reduction agent compared to the concentration of the water reduction agent in the portion of the gypsum core adjacent the second facing material and the center of the thickness of the gypsum core.

Notably, it should be understood that a portion of a gypsum core may refer to a portion of a thickness of a gypsum core, such as 1/16 inches or more, such as 1/12 inches or more, such as ⅛ inches or more, such as ¼ inches or more. In this respect, in some aspects, a portion of a gypsum core adjacent to a facing material may be 1/12 inches or more. It should be understood that a portion of a gypsum core may refer to a portion of a thickness of a gypsum core, such as ½ inches or less, such as ¼ inches or less, such as ⅛ inches or less, such as 1/12 inches or less. In this respect, in some aspects, a portion of a gypsum core adjacent to a facing material may be ½ inches or less.

Further, it should be understood that the portion of the gypsum core adjacent to the first facing material may be referred to as the first gypsum core layer. Additionally, when the gypsum core includes two gypsum core layers, the portion of the gypsum core adjacent to the second facing material may be referred to as the second gypsum core layer. Further, when the gypsum core includes three gypsum core layers, the portion of the gypsum core adjacent to the second facing material may be referred to as the third gypsum core layer.

In one aspect, the ratio of the concentration of the water reduction agent at the interface of the gypsum core and a facing material (e.g., the first facing material, the second facing material) to the concentration of the water reduction agent at the center of the thickness of the gypsum core may be from about 20:1 to about 1:20, including all incremental ratios therebetween. For instance, the ratio of the concentration of the water reduction agent at the interface of the gypsum core and a facing material (e.g., the first facing material, the second facing material) to the concentration of the water reduction agent at the center of the thickness of the gypsum core may be about 20:1 or less, such as about 15:1 or less, such as about 10:1 or less, such as about 5:1 or less, such as about 1:1 or less, such as about 1:5 or less, such as about 1:10 or less, such as about 1:15 or less. In general, the ratio of the concentration of the water reduction agent at the interface of the gypsum core and a facing material to the concentration of the water reduction agent at the center of the thickness of the gypsum core may be about 1:20 or more, such as about 1:15 or more, such as about 1:10 or more, such as about 1:5 or more, such as about 1:1 or more, such as about 5:1 or more, such as about 10:1 or more, such as about 15:1 or more.

Generally, the ratio of the concentration of a water reduction agent in a respective gypsum core layer (e.g., first gypsum core layer, second gypsum core layer, third gypsum core layer) to the concentration of the water reduction in another, different gypsum core layer (e.g., first gypsum core layer, second gypsum core layer, third gypsum core layer) may be about 20:1 or less, such as about 15:1 or less, such as about 10:1 or less, such as about 5:1 or less, such as about 1:1 or less, such as about 1:5 or less, such as about 1:10 or less, such as about 1:15 or less, including any incremental ratios therebetween. In general, the ratio of the concentration of a water reduction agent in a respective gypsum core layer to the concentration of the water reduction in another, different gypsum core layer may be about 1:20 or more, such as about 1:15 or more, such as about 1:10 or more, such as about 1:5 or more, such as about 1:1 or more, such as about 5:1 or more, such as about 10:1 or more, such as about 15:1 or more, including any incremental ratios therebetween.

In one aspect, the water reduction agent, gypsum slurry, gypsum core, and/or gypsum panel may be free of triethanolamine.

In one aspect, the gypsum slurry and/or gypsum core may include a dispersant, such as a carboxylate, a sulfonate, a phosphate, or a mixture thereof. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes a water reduction agent. In this regard, the method may include a step of also combining a water reduction agent with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerine. The one or more foam stabilizers may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The one or more foam stabilizers may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, water, a water reduction agent, a milled mixture of stucco and a water reduction agent) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In another embodiment, the water reduction agent may be applied during the gypsum board manufacturing process. In this regard, it may be applied in lieu of providing and combining with the gypsum in forming the gypsum slurry or in addition to providing and combining with the gypsum in forming the gypsum slurry. Generally, the method of application of the water reduction agent is not limited by the present disclosure and may include any method of application known in the art. Notably, the water reduction agent may be applied to the first facing material, the gypsum slurry, the second facing material, or a combination thereof. In one aspect, the water reduction agent may be applied by spraying, brushing, curtain coating, or roll coating. In one aspect, the water reduction agent may be applied to the second facing material. For instance, the water reduction agent may be applied to at least a portion of the side of the second facing material that is adjacent the gypsum slurry (i.e., the gypsum slurry facing side of the second facing material) before the second facing material is provided on the gypsum slurry. In this respect, the water reduction agent may not be applied to the gypsum slurry but may instead be applied to the second facing material before the second facing material is provided or placed on the gypsum slurry. Further, in another aspect, the water reduction agent may be applied to the gypsum slurry before the second facing material is provided or placed on the gypsum slurry. In this respect, the water reduction agent may be applied to at least a portion of the gypsum slurry adjacent the second facing material before the second facing material is provided or placed on the gypsum slurry. Additionally, in yet another aspect, the water reduction agent may be applied to the gypsum slurry before the second facing material is provided or placed on the gypsum slurry and may be applied to at least a portion of the side of the second facing material that is adjacent the gypsum slurry (i.e., the gypsum slurry facing side of the second facing material) before the second facing material is provided on the gypsum slurry.

In one aspect, the water reduction agent may be applied to the first facing material. In this respect, in one aspect, the water reduction agent may be applied to at least a portion of side of the first facing material that is adjacent the gypsum slurry before the gypsum slurry is deposited onto the first facing material.

In general, the water reduction agent may be incorporated in and/or applied to one or more facing materials (e.g., first facing material, second facing material) in an offline process. When incorporated and/or applied in an offline process, the water reduction agent may be applied to a facing material (e.g., first facing material, second facing material) before the facing material is utilized in the manufacturing process of the gypsum panel.

Generally, the water reduction agent may be present between the first facing material and the gypsum slurry or gypsum core (e.g., at the interface of the gypsum slurry or gypsum core and the first facing material) and/or may be present between the second facing material and the gypsum slurry or gypsum core (e.g., at the interface of the gypsum slurry or gypsum core and the second facing material).

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers may be a particularly suitable location for a water reduction agent. When included in a gypsum core layer, a water reduction agent may reduce the water utilized to form the respective gypsum core layer. In some aspects, as previously disclosed herein, the gypsum panel may include a first gypsum core layer, a second gypsum core layer, and a third gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as a water reduction agent. Further, the first gypsum core layer, the second gypsum core layer, and/or the third gypsum core layer may contain an additive in an amount as previously indicated herein.

As indicated herein, the gypsum core can include a water reduction agent. In this regard, in one embodiment, the first gypsum core layer may include a water reduction agent disclosed herein. In another embodiment, the second gypsum core layer may include a water reduction agent as disclosed herein. In a further embodiment, the third gypsum core layer may include a water reduction agent as disclosed herein. In an even further embodiment, the first gypsum core layer and the second gypsum core layer may include a water reduction agent as disclosed herein. In another further embodiment, the first gypsum core layer, the second gypsum core layer, and the third gypsum core layer may include a water reduction agent as disclosed herein. In yet another embodiment, a water reduction agent may be included adjacent to the first facing material and/or the second facing material.

Regardless of the above, a water reduction agent may be present in any combination of gypsum core layers. However, in one embodiment, it should be understood that one or two of the aforementioned gypsum core layers may not include a water reduction agent. In one aspect, one or more gypsum core layers may comprise the same water reduction agent. Further, in one aspect, the one or more gypsum core layers may comprise different water reduction agents. The different water reduction agents of the one or more gypsum core layers may be chosen such that it is advantageous to have a particular water reduction agent in one gypsum core layer and a different water reduction agent in another, different gypsum core layer.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lbr, such as at least about 30 pounds, such as at least about 35 lb, such as at least about 40 lbf, such as at least about 45 lbf, such as at least about 50 lbf, such as at least about 55 lbr, such as at least about 60 lbf, such as at least about 65 lbf, such as at least about 70 lbr, such as at least about 75 lbr, such as at least about 77 lbf, such as at least about 80 lbf, such as at least about 85 lbr, such as at least about 90 lbf, such as at least about 95 lbf, such as at least about 100 lbr as tested according to ASTM C1396-17. The nail pull resistance may be about 400 lbr or less, such as about 300 lbr or less, such as about 200 lbr or less, such as about 150 lbr or less, such as about 140 lbf or less, such as about 130 lbr or less, such as about 120 lbr or less, such as about 110 lbr or less, such as about 105 lbr or less, such as about 100 lbr or less, such as about 95 lbr or less, such as about 90 lbr or less, such as about 85 lbr or less, such as about 80 lbr or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lbr, such as at least about 10 lbf, such as at least about 11 lbf, such as at least about 12 lbf, such as at least about 15 lbf, such as at least about 18 lbf, such as at least about 20 lbr as tested according to ASTM C1396-17. The gypsum panel may have a core hardness of 50 lb or less, such as about 40 lbr or less, such as about 35 lb or less, such as about 30 lbr or less, such as about 25 lbr or less, such as about 20 lbr or less, such as about 18 lbr or less, such as about 15 lbf or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lbf, such as at least about 10 lbf, such as at least about 11 lbf, such as at least about 12 lbr, such as at least about 15 lbf, such as at least about 18 lbr, such as at least about 20 lbf, such as at least about 24 lbf, such as at least about 28 lbf, such as at least about 30 lbf, such as at least about 33 lbr as tested according to ASTM C1396-17 and ASTM C473-19. The gypsum panel may have an edge hardness of about 50 lbr or less, such as about 40 lbr or less, such as about 35 lbf or less, such as about 30 lbr or less, such as about 25 lbr or less, such as about 20 lbr or less, such as about 18 lbr or less, such as about 15 lbr or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Test Methods

Stiffening Time: The stiffening time is the amount of time for a line drawn through the gypsum patty to remain visible (e.g., unhealed). In particular, a paper clip tip was used to draw a line through the gypsum patty. The stiffening time was determined as the time at which the line remained visible or it no longer healed.

Set Time: The initial or ¼ lb set time is the time until set as determined according to ASTM C266 using a ¼ lb Gilmore needle.

Slump Test: The test is conducted after wiping a brass cylinder having a wall thickness of about 0.07 inches, a height of about 4 inches, and an inner diameter of about 2 inches with a low-viscosity lubricating oil. Excess oil was drained off the surfaces of the cylinder. The cylinder then was placed upright onto a center portion of a clean (i.e., no scratches), dry glass plate having the following dimensions: about 10 inches in length, about 10 inches in width, and about 0.1875 inch thick. The gypsum patty was poured into the cylinder such that the cylinder was completely filled with a slight excess. The scoop can be a clean metal or plastic scoop of convenient size or can be formed from disposable gypsum board paper. The excess was screed off to a level with the top of the cylinder without dropping any of the gypsum patty onto the surface of the glass plate. Immediately, and at least within about 10 seconds of removing excess gypsum patty, the cylinder was raised vertically with a smooth and uniform motion at a moderate (not rapid) speed, and the gypsum patty contained within the cylinder was allowed to slump to a circular patty onto the surface of the glass plate. After the gypsum patty had solidified, the glass plate was turned over and the diameter of the slump in contact with the glass plate was measured to the nearest ⅛ inch. In particular, the average of two measurements was reported wherein the measurements are taken at right angles to each other.

### Example 1

Gypsum patties were made which included stucco, water, a water reduction agent (e.g., urea), and/or “UPS” (i.e., a ball-milled mixture of stucco and urea). A gypsum patty is formed by a process including mixing water with stucco, a water reduction agent, and/or UPS. The mixture is mixed for ten (10) seconds to form a gypsum patty. Sample 1, which is the control sample, did not contain a water reduction agent or UPS. Sample 2 contained urea as a water reduction agent in an amount of 20 wt. % based on the weight of stucco in the gypsum slurry that forms the gypsum patty. Sample 3 contained “UPS”, which, for Sample 3, is a ball-milled mixture of 84 wt. % stucco and 16 wt. % urea. The mixture of 84 wt. % stucco and 16 wt. % urea was ball-milled for one hour. Sample 3 contained 50 grams of UPS and 25 grams of water for a weight ratio of water to UPS of 1:2 or 0.5. Sample 4 contained 50 grams of UPS and 13 grams of water for a weight ratio of water to UPS of 13:50 or 0.26.

TABLE 1

| | Amount | Amount | Amount | Amount | Amount of | | Stiffening | |
|---|---|---|---|---|---|---|---|---|
| | of Stucco | of Urea | of UPS | of Water | Dispersant | Slump | Time | Set Time |
| Sample | [g] | [g] | [g] | [g] | [g] | [in] | [min:sec] | [min:sec] |
| Sample 1 | 50 | 0 | 0 | 32.5 | 0 | 3 | 3:06 | 6:43 |
| Sample 2 | 50 | 10 | 0 | 25 | 0 | 3 | 9:23 | 21:02 |
| Sample 3 | 0 | 0 | 50 | 25 | 0 | 4 | 11:15 | 22:26 |
| Sample 4 | 0 | 0 | 50 | 13 | 2 | 3 | 10:05 | 19:32 |

As observed in Table 1, the stiffening time and set time for Samples 2-4 demonstrate enhanced fluidity as compared to Sample 1.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core comprising gypsum and a water reduction agent, the water reduction agent being present in the gypsum panel in an amount from about 1 wt. % to about 20 wt. % based on the weight of the gypsum core; and
a first facing material and a second facing material sandwiching the gypsum core.

2. The gypsum panel of claim 1, wherein the water reduction agent comprises an amide.

3. The gypsum panel of claim 2, wherein the amide is urea.

4. The gypsum panel of claim 1, wherein the gypsum core comprises a dispersant.

5. The gypsum panel of claim 4, wherein the dispersant comprises a sulfonate, a carboxylate, or a combination thereof.

6. The gypsum panel of claim 4, wherein the dispersant comprises a naphthalene sulfonate, a lignosulfonate, a polycarboxylate ether, or a combination thereof.

7. The gypsum panel of claim 1, wherein the gypsum core is formed from a gypsum slurry comprising a milled mixture of the water reduction agent and a stucco.

8. The gypsum panel of claim 1, wherein the gypsum core is formed from a gypsum slurry comprising a milled mixture of the water reduction agent and gypsum.

9. The gypsum panel of claim 7, wherein the stucco is present in the milled mixture in an amount from about 50 wt. % to about 95 wt. %.

10. The gypsum panel of claim 7, wherein the water reduction agent is present in the milled mixture in an amount from about 1 wt. % to about 60 wt. %.

11. The gypsum panel of claim 1, wherein the water reduction agent has an average particle size from about 50 microns to about 5 mm.

12. The gypsum panel of claim 1, wherein the water reduction agent has an average particle size from about 500 microns to about 5 mm.

13. The gypsum panel of claim 1, wherein the particle size distribution of the water reduction agent is such that a US standard mesh size of 10 retains from 90 wt. % to about 100 wt. % of the water reduction agent.

14. The gypsum panel of claim 1, wherein the water reduction agent is present in the gypsum panel in an amount from about 3 wt. % to about 20% based on the weight of the gypsum core.

15. The gypsum panel of claim 1, wherein the water reduction agent has a formaldehyde content from 0 wt. % to about 5 wt. %.

16. The gypsum panel of claim 1, wherein the water reduction agent has a biuret content from 0 wt. % to about 5 wt. %.

17. The gypsum panel of claim 1, wherein the water reduction agent is present in the gypsum panel in an amount from about 0.001 lbs/MSF to 50 lbs/MSF.

18. The gypsum panel of claim 1, wherein the gypsum core comprises at least two gypsum core layers, wherein only one gypsum core layer comprises the water reduction agent.

19. The gypsum panel of claim 1, wherein the gypsum core has a concentration gradient of the water reduction agent over a thickness of the gypsum core.

20. The gypsum panel of claim 1, wherein the water reduction agent is ball-milled.

21. A method for making the gypsum panel of claim 1 comprising:
providing a first facing material;
depositing a gypsum slurry comprising stucco, water, and a water reduction agent onto the first facing material,
providing a second facing material on the gypsum slurry; and
allowing the stucco to convert to calcium sulfate dihydrate
wherein the water reduction agent is present in the gypsum panel in an amount from about 1 wt. % to about 20 wt. % based on the weight of the gypsum core.

22. A gypsum panel comprising:
a gypsum core comprising gypsum and a water reduction agent, wherein the gypsum core is formed from a gypsum slurry comprising a ball-milled mixture of the water reduction agent and a stucco; and
a first facing material and a second facing material sandwiching the gypsum core.
